(19) United States
(12) Patent Application Publication
(10) Pub. No.: US 2019/0028332 A1
(43) Pub. Date: Jan. 24, 2019

(54) CONFIGURATION INFORMATION PUSH METHOD AND DEVICE

(71) Applicant: ALIBABA GROUP HOLDING LIMITED, Grand Cayman (KY)

(72) Inventors: QIAOYI DING, HANGZHOU (CN); FENGTING ZHANG, HANGZHOU (CN)

(21) Appl. No.: 16/144,621

(22) Filed: Sep. 27, 2018

Related U.S. Application Data
(63) Continuation of application No. PCT/CN2017/076890, filed on Mar. 16, 2017.

(30) Foreign Application Priority Data
Mar. 28, 2016 (CN) 201610183710.1

(51) Int. Cl. H04L 12/24; H04L 12/26; H04L 29/08

(52) U.S. Cl. CPC H04L 41/082; H04L 67/02; H04L 67/34; H04L 43/10

(57) ABSTRACT

The present invention provides a configuration information push method and device. The method includes: obtaining a polling request sent by a client; determining whether configuration information of configuration items in the polling request is consistent with current configuration information of corresponding local configuration items, if yes, keeping a short connection to the client; monitoring the configuration information of the corresponding local configuration items, and if, in a duration of the short connection, current configuration information of at least one target configuration item in the local configuration items is inconsistent with configuration information of a corresponding configuration item in the polling request, pushing the current configuration information of the target configuration item to the client, so that the client updates a configuration of a corresponding target configuration item to the current configuration information.

### CROSS REFERENCE TO RELATED APPLICATIONS

The present application is a continuation application of the International Patent Application No. PCT/CN2017/076890, filed on Mar. 16, 2017, and titled “Configuration Information Pushing Method and Device.” The PCT Application PCT/CN2017/076890 claims priority to the Chinese Patent Application No. 201610183710.1 filed on Mar. 28, 2016 and entitled “Configuration Information Pushing Method and Device.” The entire contents of all of the above applications are incorporated herein by reference in their entirety.

### TECHNICAL FIELD

The present invention relates to the communications field, and in particular, to a configuration information push method and device.

### BACKGROUND

When an application system runs a program, to flexibly cope with a requirement change, some configurations that are often changed are saved into a file. In different deployment and application scenarios, different configurations need to be changed before deployment is performed. When a configuration is changed, based on a real-time configuration push system, the application system can have the configuration change that immediately takes effect without restarting the program. For example, a database cluster is used in a transaction platform, and when a program is started, a connection is established to a database by using a group of database connection parameters. When a peak hour for use of the transaction platform arrives, some database connection parameters need to be switched. In this case, based on the real-time configuration push system, an application on the transaction platform can immediately take effect without restarting the application, so that execution of a service is not affected. The real-time configuration push system needs to efficiently discover that a new configuration value of a server is inconsistent with a previous configuration value of a client, and pushes the new configuration value to the client in real time.

### SUMMARY

The present disclosure provides a configuration information push method and device, to resolve a problem that when an existing client periodically performs polling on a server, real-time performance of configuration pushing cannot be ensured due to short polling duration. To achieve the foregoing objective, the present disclosure provides a configuration information push method. According to one aspect, the method includes: obtaining a polling request from a client, wherein the polling request comprises configuration information of configuration items, determining whether the configuration information of the configuration items in the polling request is consistent with current configuration information of corresponding local configuration items, keeping a short connection to the client within a preset polling duration if a determining result is yes, during the short connection, monitoring the current configuration information of corresponding local configuration items, and if, current configuration information of a target configuration item in the corresponding local configuration items is inconsistent with configuration information of a corresponding configuration item in the polling request, pushing the current configuration information of the target configuration item to the client for the client to update a configuration of a corresponding target configuration item at the client to the current configuration information.

According to another aspect, the present disclosure further provides a configuration information updating method, including: sending a polling request to a server for the server to determine whether configuration information of configuration items in the polling request is consistent with current configuration information of corresponding local configuration items at the server, receiving a connection keeping request for keeping a short connection to the server within a preset polling duration, wherein the connection keeping request is sent by the server when the server determines that the configuration information of the configuration items in the polling request is consistent with the current configuration information of the corresponding local configuration items, receiving, from the server, a push message including current configuration information of a target configuration item, wherein the push message is sent by the server when the server determines that current configuration information of the target configuration item in the corresponding local configuration items is inconsistent with configuration information of a corresponding configuration item in the polling request, and updating a configuration of a corresponding target configuration item at the client to the current configuration information.

According to a further aspect, the present disclosure provides a system for pushing configuration information. The system includes one or more processors and a non-transitory computer-readable storage medium storing instructions that, when executed by the processor, cause the system to perform a configuration information pushing method. The method includes obtaining a polling request from a client, wherein the polling request comprises configuration information of configuration items, keeping a short connection to the client within a preset polling duration, during the short connection, monitoring the current configuration information of corresponding local configuration items, and if, current configuration information of a target configuration item in the corresponding local configuration items is inconsistent with configuration information of a corresponding configuration item in the polling request, pushing the current configuration information of the target configuration item to the client for the client to update a configuration of a corresponding target configuration item at the client to the current configuration information.

According to a further aspect, the present disclosure provides a configuration information push device, including: an obtaining module, configured to obtain a polling request sent by a client, where the polling request includes configuration information of configuration items, a determining module, configured to determine whether the configuration information of the configuration items in the polling request is respectively consistent with current configuration information of corresponding local configuration items, a connection keeping module, configured to keep a short connection to the client within a preset polling duration if a determining result is yes, and a pushing module, configured to push, if, in the duration of the short connection, current configuration information of at least one target configuration item in the local configuration items is inconsistent with configuration information of a corresponding configuration item in the polling request, the current configuration information of the target configuration item to the client, so that the client updates a configuration of a corresponding target configuration item to the current configuration information.

According to a further aspect, the present disclosure provides a configuration information updating device, including: a sending module, configured to send a polling request to a server, so that the server determines whether configuration information of configuration items in the polling request is respectively consistent with current configuration information of corresponding local configuration items, where the polling request includes the configuration information of the configuration items, a first receiving module, configured to receive a connection keeping request for keeping a short connection to the server within a preset polling duration, where the connection keeping request is sent by the server when the server determines that the configuration information of the configuration items in the polling request is respectively consistent with the current configuration information of the corresponding local configuration items, a second receiving module, configured to receive, from the server, a push message used to push current configuration information of a target configuration item, where the push message is sent by the server when the server determines, in the duration of the short connection, that current configuration information of at least one target configuration item is inconsistent with configuration information of a corresponding configuration item in the polling request, and the target configuration item is a configuration item in the local configuration items, and an updating module, configured to update a configuration of the target configuration item to the current configuration information.

According to another aspect, an information push method comprises: obtaining a polling request from a client, wherein the polling request comprises configuration information of configuration items; during a short connection to the client, monitoring current configuration information of corresponding local configuration items; and if, current configuration information of a target configuration item in the corresponding local configuration items is inconsistent with configuration information of a corresponding configuration item in the polling request, pushing the current configuration information of the target configuration item to the client for the client to update a configuration of a corresponding target configuration item at the client to the current configuration information.

In some embodiments, before the monitoring current configuration information of corresponding local configuration items, the method further comprises: determining whether the configuration information of the configuration items in the polling request is consistent with current configuration information of corresponding local configuration items; if the configuration information of the configuration items in the polling request is consistent with current configuration information of corresponding local configuration items, keeping the short connection to the client within a preset polling duration; and if the configuration information of the configuration items in the polling request is inconsistent with current configuration information of corresponding local configuration items; sending a polling response to the client, wherein the polling response comprises identity information of the target configuration item; receiving a configuration information request sent by the client; and sending the current configuration information of the target configuration item to the client for the client to update the configuration of the corresponding target configuration item at the client to the current configuration information.

In some embodiments, the method further comprises: breaking the short connection to the client after pushing the current configuration information to the client or when the preset polling duration is reached.

In some embodiments, after the breaking the short connection to the client, the method further comprises: after a preset time interval is reached, re-obtaining a polling request from the client.

In some embodiments, the keeping the short connection to the client within a preset polling duration comprises: sending an asynchronous processing request to the client to cause the client to keep the short connection within the preset polling duration.

According to another aspect, an information updating method comprises: sending a polling request to a server, wherein the polling request comprises configuration information of configuration items; receiving, from the server, a push message including current configuration information of a target configuration item, after the server determines that the current configuration information of the target configuration item in corresponding local configuration items is inconsistent with configuration information of a corresponding configuration item in the polling request; and updating a configuration of a corresponding target configuration item at the client to the current configuration information.

In some embodiments, the sending a polling request to a server comprises: sending the polling request to the server for the server to determine whether configuration information of configuration items in the polling request is consistent with current configuration information of corresponding local configuration items at the server; and receiving, from the server, a connection keeping request for keeping a short connection to the server within a preset polling duration, after the server determines that the configuration information of the configuration items in the polling request is consistent with the current configuration information of the corresponding local configuration items, wherein: the connection keeping request is an asynchronous processing request instructing to keep the short connection to the server within the preset polling duration.

In some embodiments, before the receiving, from the server, a push message, the method further comprises: sending a configuration information request to the server to request the server to deliver the current configuration information of the target configuration item.

In some embodiments, the method further comprises: receiving an indication message for breaking the short connection from the server, after the preset polling duration is reached; and after a preset time interval is reached, re-sending a polling request to the server.

In some embodiments, the method further comprises: after a preset time interval, re-sending a polling request to the server.

According to another aspect, a system for pushing information comprises: one or more processors and a non-transitory computer-readable storage medium storing instructions that, when executed by the processor, cause the system to perform an information pushing method, the method comprising: obtaining a polling request from a client, wherein the polling request comprises configuration information of configuration items; keeping a short connection to the client within a preset polling duration; during the short connection, monitoring the current configuration information of corresponding local configuration items; and if, current configuration information of a target configuration item in the corresponding local configuration items is inconsistent with configuration information of a corresponding configuration item in the polling request, pushing the current configuration information of the target configuration item to the client for the client to update a configuration of a corresponding target configuration item at the client to the current configuration information.

In some embodiments, the method further comprises: after pushing the current configuration information to the client, breaking the short connection.

In some embodiments, before the keeping a short connection to the client within a preset polling duration, the method further comprises, if the configuration information of the configuration items in the polling request is inconsistent with current configuration information of corresponding local configuration items; sending a polling response to the client, wherein the polling response comprises identity information on the target configuration item; receiving a configuration information request sent by the client; and sending the current configuration information of the target configuration item to the client for the client to update the configuration of the corresponding target configuration item at the client to the current configuration information.

In some embodiments, the method further comprises: when the preset polling duration is reached, breaking the short connection to the client.

In some embodiments, after the breaking the short connection to the client, the method comprises: after a preset time interval is reached, re-obtaining a polling request from the client.

In some embodiments, after the breaking the short connection to the client, the method further comprises: after a preset time interval is reached, re-obtaining a polling request from the client.

In some embodiments, the keeping a short connection to the client within a preset polling duration comprises: sending an asynchronous processing request to the client to cause the client to keep the short connection within the preset polling duration.

In some embodiments, the short connection is a Hypertext Transfer Protocol (HTTP) short connection.

According to the configuration information push method and device that are provided in the present disclosure, a polling request sent by a client is obtained, whether configuration information of configuration items in the polling request is respectively consistent with current configuration information of corresponding local configuration items is determined, if yes, a short connection to the client is kept within a preset polling duration, and if, in the duration of the short connection, current configuration information of at least one target configuration item in the local configuration items at the server is inconsistent with configuration information of a corresponding configuration item in the polling request, the current configuration information of the target configuration item is pushed to the client, so that the client updates a configuration of a corresponding target configuration item at the client to the current configuration information. In embodiments, when configuration information of a configuration item is not updated, a short connection needs to be kept within preset polling duration, so that the polling duration is correspondingly extended, and a change in the configuration information of the configuration item can be sensed in time, thereby ensuring real-time performance of configuration information pushing.

### BRIEF DESCRIPTION OF THE DRAWINGS

FIG. 1 is a schematic flowchart of a configuration information push method according to Embodiment 1 of the present invention;

FIG. 2 is a schematic flowchart of a configuration information push method according to Embodiment 2 of the present invention;

FIG. 3 is a schematic application diagram of the configuration information push method according to Embodiment 2 of the present invention;

FIG. 4 is a schematic structural diagram of a configuration information push device according to Embodiment 3 of the present invention;

FIG. 5 is a schematic structural diagram of a configuration information push device according to Embodiment 4 of the present invention; and

FIG. 6 is a schematic structural diagram of a configuration information push system according to Embodiment 5 of the present invention.

### DETAILED DESCRIPTION OF THE INVENTION

The following describes in detail a configuration information push method and device that are provided in embodiments of the present invention with reference to the accompanying drawings.

### Embodiment 1

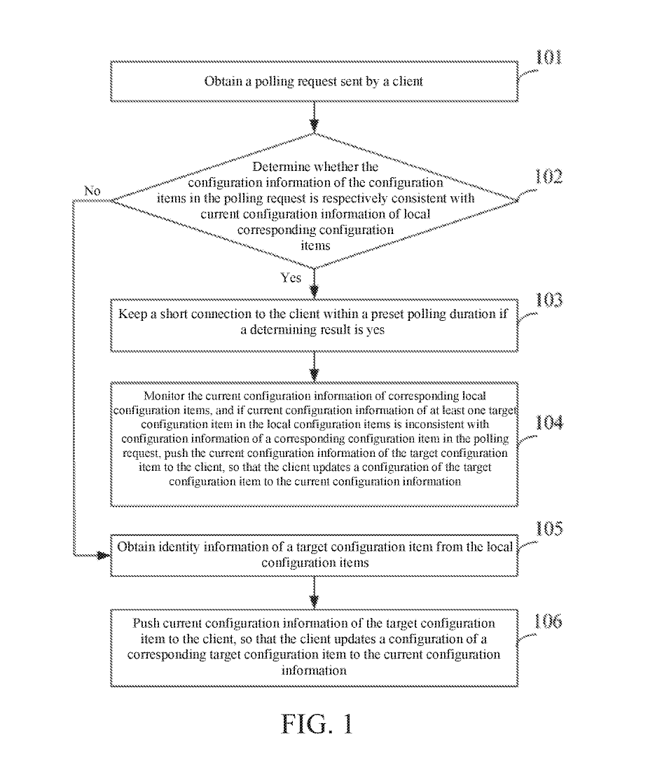

FIG. 1 shows a schematic flowchart of a configuration information push method according to Embodiment 1 of the present disclosure. This embodiment can be performed by a server. The configuration information push method includes the following steps.

S101: Obtain a polling request from a client.

The polling request includes configuration information of configuration items at the client. A short connection is established between the client and the server. In this embodiment, the server establishes the short connection to the client based on the HTTP. Since the HTTP communication protocol is a text protocol, cross-language pushing of configuration information can be implemented.

After the short connection is established, the server may continually receive the polling request from the client through the short connection, to perform polling on a configuration change of each configuration item in the server. The polling request includes the configuration information of the configuration items, and the configuration information is information configured by the server for the configuration item last time. Configuration information is a configuration value of a configuration item.

S102 (optional): Determine whether the configuration information of the configuration items in the polling request is consistent with current configuration information of corresponding local configuration items at the server.

After receiving the polling request, the server determines whether the current configuration information of the locally stored configuration items is respectively consistent with the configuration information of the corresponding configuration items that is sent by the client. The locally stored configuration items are completely the same as the configuration items in the client, but configuration information of a local configuration item may be different from configuration information of a configuration item in the client. For example, the configuration items include a configuration item 1, a configuration item 2, and a configuration item 3, and in the polling request, configuration information of the configuration item 1 is data 1, configuration information of the configuration item 2 is data 2, and configuration information of the configuration item 3 is data 3. When configuration information of a locally stored configuration item 1 to a locally stored configuration item 3 is respectively the data 1 to the data 3, current configuration information of the locally stored configuration items is respectively consistent with the configuration information of the corresponding configuration items that is sent by the client. That is, the determining result is yes, and step S103 is performed. If configuration information of the locally stored configuration item 2 is data 4, the current configuration information of the locally stored configuration items is not consistent with the configuration information of the corresponding configuration items that is sent by the client. That is, the determining result is no, and step S105 is performed.

S103 (optional): Keep the short connection to the client within a preset polling duration.

When it is determined that the current configuration information of the locally stored configuration items is consistent with the configuration information of the corresponding configuration items that is sent by the client, that is, configuration information of a configuration item in the client is not updated, the server may keep the short connection to the client within the preset polling duration. Specifically, the server sends an asynchronous processing request to the client. The asynchronous processing request instructs the client to keep the short connection to the server within the preset polling duration. For example, the short connection to the client may be kept by using an asynchronous Servlet.

S104: Monitor the current configuration information of the corresponding local configuration items at the server. In the duration of the short connection, configuration information of one or more of the corresponding local configuration items at the server may change. The server may detect that the current configuration information of the one configuration item in the local configuration items at the server is inconsistent with configuration information of a corresponding configuration item in the polling request. For the convenience of description, the one or more configuration items that has inconsistent configuration information may be called “target configuration item.” The client also has a corresponding target configuration item. The configuration information of the target configuration item at the server is inconsistent with the configuration information of the target configuration item at the client. The target configuration items refer to the ones that have inconsistent configuration information, but do not refer to a particular configuration item. The server then pushes the current configuration information of the target configuration item to the client, so that the client updates a configuration of a corresponding target configuration item at the client to the current configuration information.

When the duration of the short connection to the client has not reached the preset polling duration, when current configuration information of at least one target configuration item in the locally stored configuration items in the server is inconsistent with configuration information of a corresponding configuration item in the polling request, that is, configuration information of the target configuration item in the server is changed, the server may push the current configuration information of the target configuration item to the client.

In one embodiment, the server may send, to the client, a polling response indicating a configuration change. The polling response includes the current configuration information of the target configuration item. For example, when the target configuration item is the configuration item 2, the polling response is: configuration item 2, data 4. Correspondingly, after receiving the current configuration information of the target configuration item, the client needs to update the configuration of the corresponding target configuration item to the current configuration information.

In this embodiment, when the target configuration item is obtained, identity information of the target configuration item and the current configuration information of the target configuration item are directly sent to the client, thereby reducing a processing time of a polling result, and improving real-time performance of configuration information pushing.

Optionally, after obtaining the target configuration item, the server may first add identity information of the target configuration item to the polling response and send the polling response to the client, and after receiving a configuration information request message sent by the client, the server sends a configuration value of the target configuration item to the client. Although a processing time of a polling result is extended, when the client does not need to update the configuration item, a waste of resources can be avoided.

Further, after the duration of the short connection to the client reaches the preset polling duration, if the current configuration information of the locally stored configuration items in the server is respectively consistent with the configuration information of the corresponding configuration items in the polling request, the server may send, to the client, a polling response indicating no configuration change. The polling response is null.

In this embodiment, the short connection to the client may be kept until a preset polling time is reached and may be broken after that. When the short connection is kept within the preset polling time, the server monitors and detects that current configuration information of at least one target configuration item in the local configuration items is inconsistent with previous configuration information of a corresponding configuration item that is sent to the client, the server may deliver the current configuration information of the target configuration item to the client, so that configuration information of the configuration item in the client is consistent with the configuration information of the corresponding configuration item in the server.

Alternatively, in the duration of the short connection, after a user corresponding to the client actively changes configuration information of at least one configuration item in the polling request, the configuration information is added to the polling request and sent to the server. The server can also detect that current configuration information of at least one target configuration item in the local configuration items is different from the changed configuration information of the configuration item in the polling request, and the server may deliver the current configuration information of the target configuration item to the client, so that the client reconfigures the target configuration item of the client with the configuration information delivered by the server.

Optionally, in the duration of the short connection, when inconsistency between current configuration information of at least one target configuration item in the local configuration items and configuration information of a corresponding configuration item in the polling request occurs the first time, the server pushes the current configuration information of the target configuration item to the client, and then, immediately breaks the short connection to the client. After the current configuration information of the target configuration item is sent, it indicates that a configuration in the client is already the newest configuration. The short connection to the client can be immediately broken. When the short connection to the client is broken, after a next preset time interval is reached, a polling request sent by the client can continue to be received, so as to continue to update the configuration item in the client in real time.

To improve real-time performance of configuration updating for the client, a time interval for performing polling on the server can be shortened, so that after configuration information of a configuration item in the server is updated, information about a corresponding configuration item can be updated in the client more quickly.

S105 (optional): Obtain a target configuration item from the local configuration items.

As shown in FIG. 1, in S102, if it is determined that configuration information of at least one configuration item in the local configuration items is inconsistent with configuration information of a corresponding configuration item in the polling request, it indicates that current configuration information of the at least one configuration item whose configuration information is changed needs to be sent to the client, and the at least one configuration item whose configuration information is changed is obtained. In this embodiment, the at least one configuration item whose configuration information is inconsistent with the configuration information of the corresponding configuration item in the polling request is referred to as the target configuration item.

S106 (optional): Push current configuration information of the target configuration item to the client, so that the client updates a configuration of a corresponding target configuration item to the current configuration information.

After obtaining the target configuration item, the server pushes the current configuration information of the target configuration item to the client. For example, the server may send, to the client, a polling response indicating a configuration change. The polling response includes the current configuration information of the target configuration item. Correspondingly, after receiving the current configuration information of the target configuration item the client needs to update the configuration of the corresponding target configuration item at the client to the current configuration information. After the current configuration information of the target configuration item is pushed, the short connection to the client is broken, so that after a next preset time interval is reached, a polling request sent by the client continues to be received, so as to update the configuration item in the client in real time.

According to the configuration information push method provided in this embodiment, a polling request sent by a client is obtained; whether configuration information of configuration items in the polling request is respectively consistent with current configuration information of corresponding local configuration items is determined; if yes, a short connection to the client is kept within preset polling duration; and if in the duration of the short connection, current configuration information of at least one target configuration item in the local configuration items is inconsistent with configuration information of a corresponding configuration item in the polling request, the current configuration information of the target configuration item is pushed to the client, so that the client updates a configuration of the corresponding target configuration item at the client to the current configuration information. In this embodiment, when configuration information of a configuration item is not updated, the short connection needs to be kept within the preset polling duration, so that the polling duration is correspondingly extended, and a change in the configuration information of the configuration item can be sensed in time, thereby ensuring real-time performance of configuration information pushing.

### Embodiment 2

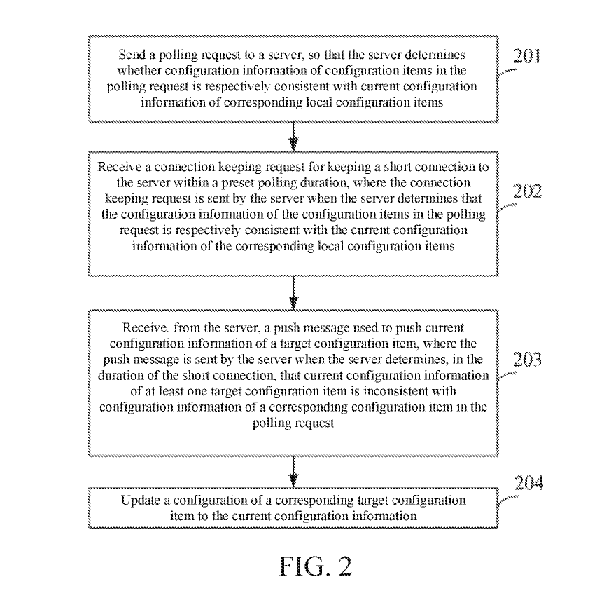

FIG. 2 is a schematic flowchart of a configuration information push method according to Embodiment 2 of the present invention. This embodiment is performed by a client. The configuration information push method includes the following steps.

S201: Send a polling request to a server, so that the server determines whether configuration information of configuration items in the polling request is respectively consistent with current configuration information of corresponding local configuration items at the server.

The polling request includes configuration information of configuration items. In this embodiment, before sending the polling request to the server, the client needs to establish a short connection to the server based on the HTTP. The HTTP communication protocol is a text protocol, so that cross-language pushing of configuration information can be implemented.

After the connection is established, the client sends the polling request to the server through the short connection, to performing polling on a configuration change of each configuration item in the server. The polling request includes the configuration information of the configuration items, and the configuration information is information configured by the server for the configuration last time. Configuration information is a configuration value of a configuration item.

Correspondingly, after receiving the polling request, the server determines whether current configuration information of locally stored configuration items is respectively consistent with configuration information of corresponding configuration items that is sent by the client. The locally stored configuration items are all the same as the configuration items in the client, but configuration information of a local configuration item may be different from configuration information of a configuration item in the client.

S202 (optional): Receive a connection keeping request for keeping a short connection to the server within a preset polling duration that is sent by the server, where the connection keeping request is sent by the server when the server determines that the configuration information of the configuration items in the polling request is respectively consistent with the current configuration information of the corresponding local configuration items.

When the server determines that the current configuration information of the locally stored configuration items is consistent with the configuration information of the corresponding configuration items that is sent by the client, it indicates that the configuration information of the configuration items in the client is not updated. In this case, the client receives the connection keeping request for keeping the short connection to the server within the preset polling duration, and after receiving the connection keeping request, the client continues keeping the short connection within the preset polling duration.

Further, the connection keeping request is an asynchronous processing request used to instruct to keep the short connection to the server within the preset polling duration. For example, the short connection to the server may be kept within the preset polling duration by using an asynchronous Servlet.

S203: Receive, from the server, a push message used to push current configuration information of a target configuration item, where the push message is sent by the server when the server determines, in the duration of the short connection, that current configuration information of at least one target configuration item is inconsistent with configuration information of a corresponding configuration item in the polling request, and the target configuration item is a configuration item in the local configuration items at the server.

In the duration of the short connection to the client within the preset polling duration, if current configuration information of at least one target configuration item in the locally stored configuration items in the server is inconsistent with configuration information of a corresponding configuration item in the polling request, that is, configuration information of the target configuration item of the server is changed, the client receives the push message sent by the server. The push message includes the current configuration information of the target configuration item.

Optionally, the client receives a polling response indicating a configuration change from the server. The polling response includes identity information of the target configuration item. After receiving the polling response, the client sends a configuration request message to the server, to request the server to deliver the current configuration information of the target configuration item to the client.

Further, after the short connection to the client reaches the preset polling duration, if the current configuration information of the locally stored configuration items in the server is respectively consistent with the configuration information of the corresponding configuration items in the polling request, the client receives a polling response indicating no configuration change from the server, where the polling response is null; and the client senses that the server breaks the short connection to the client. Specifically, the client may obtain an indication message indicating that the short connection is broken, and after receiving the indication message, after a next preset time interval is reached, the client may continue to send a polling request to the server, so as to update the configuration item in real time.

S204: Update a configuration of the target configuration item to the current configuration information.

Correspondingly, after receiving the current configuration information of the target configuration item, the client needs to update the configuration of the target configuration item to the current configuration information.

During actual application, after sending the push message, the server immediately breaks the short connection to the client. Correspondingly, after the server breaks the short connection, the client can immediately sense that the short connection is broken. To keep updating the configuration item in the client in real time, the client needs to start timing immediately according to a preset time interval, and after a next time interval is reached, re-sends a polling request to the server. In this embodiment, a time interval for performing polling on the server can be shortened, so that after configuration information of a configuration item in the server is updated, information of a corresponding configuration item can be updated in the client more quickly, thereby improving real-time performance of configuration updating in the client.

According to the configuration information push method provided in this embodiment, a polling request is sent to a server, so that the server determines whether configuration information of configuration items in the polling request is respectively consistent with current configuration information of corresponding local configuration items; if yes, a short connection to the server is kept within a preset polling duration; and if, in the duration of the short connection, current configuration information of at least one target configuration item in the local configuration items is inconsistent with configuration information of a corresponding configuration item in the polling request, a client receives a push message including the current configuration information of the target configuration item, and the client updates a configuration of a corresponding target configuration item at the client to the current configuration information. In this embodiment, when configuration information of a configuration item is not updated, a short connection needs to be kept within preset polling duration, so that the polling duration is correspondingly extended, and a change in the configuration information of the configuration item can be sensed in time, thereby ensuring real-time performance of configuration information pushing.

FIG. 3 shows a specific application example of the foregoing embodiment of the present invention, and is used to explain and describe the foregoing embodiment. In this example, a client interacts with a server by using an HTTP short connection, and the client periodically initiates a polling request through the short connection, to perform polling on the server.

S301: A client sends a polling request to a server.

Two configuration items: a configuration item 1 and a configuration item 2 are subscribed to in the polling request. A configuration value of the configuration item is dataid1 group1, and a configuration value of the configuration item 2 is dataid2 group2.

Assuming that at a moment of 0.0 s, the client sends the polling request to the server, to perform polling on a change state of configuration information of a configuration item. Generally, the configuration information of the configuration item is a configuration value of the configuration item.

S302: After receiving the polling request, the server determines whether configuration values of locally stored configuration items are consistent with configuration values of corresponding configuration items in the polling request.

If yes, step S303 is performed.

S303: The server keeps the short connection to the client within a preset polling duration based on an asynchronous Servlet technology.

If yes, it indicates that the server did not update the configuration values of the configuration items, that is, a polling result is no change. The server keeps the short connection to the client within the preset polling duration based on the asynchronous Servlet technology. In this example, the preset polling duration is 5 s.

S304: The server sends a polling response to the client.

The polling response includes null. In this example, the preset polling duration is 5 s, and the server waits for reaching of the polling duration of 5 s, that is, a moment at the 5.0 s. In this example, within a time of 5 s within which the short connection is kept, the configuration information of the configuration item 1 and the configuration item 2 is not changed in the server, so that the server sends, to the client, a polling response indicating no configuration change, where the polling response includes null, and breaks the short connection.

S305: After a preset time interval is reached, the client re-sends a polling request to the server.

After the client senses that the short connection to the server is broken, when a next preset time interval is reached, the client re-sends a polling request to the server, to perform polling on a configuration change. In this example, the preset time interval is 1 ms, that is, a moment of 5.001 s. A polling request is re-sent to the server. A configuration item and configuration information of the configuration item are subscribed to in the polling request. In this example, the configuration items that are subscribed to are the configuration item 1 and the configuration item 2. After the previous polling, polling results of the configuration item 1 and the configuration item 2 are no change, so that the configuration value of the configuration item is still dataid1 group1, and the configuration value of the configuration item 2 is still dataid2 group2.

S306: The server determines whether configuration values of locally stored configuration items are consistent with configuration values of corresponding configuration items in the polling request.

If yes, step S307 is performed.

S307: The server keeps a short connection to the client within preset polling duration based on an asynchronous Servlet technology.

S308: When the short connection is kept within the polling duration, the server monitors the confirmation of the local configuration items, and when the configuration value of the configuration item 2 is changed, the server sends, to the client, a polling response indicating a configuration change, where the polling response carries identity information of the configuration item 2.

For example, in the duration of the short connection within the polling duration, the configuration item 2: dataid2 group2 is changed Is after the client sends the polling response indicating no configuration change, that is, at a moment of 6.0 s, and the polling response indicating a configuration change is sent to the client. The polling response includes the configuration item 2, and the configuration item 2 is the target configuration item. Assuming that the time for obtaining the information on the change obtained through polling is 3 ms, the polling response indicating a configuration change is sent to the client at a moment of 6.003 s. That is, at the moment of 6.003 s, the client senses the configuration change, and the moment of 6.003 s is close to a time at which the configuration is changed, that is, the moment of 6.0 s, so that it may be considered that the client senses the configuration change in real time.

S309: The client sends a configuration value request to the server.

Specifically, after receiving, at the moment of 6.003 s, the polling response indicating a configuration change, the client sends the configuration value request to the server at 6.004 s, to request the newest configuration value in the server. The newest configuration value is a current configuration value of the configuration item 2.

S310: The server sends newest configuration value of the configuration item 2 to the client.

After receiving the configuration value request, the server sends the newest configuration value of the configuration item 2 to the client at a moment of 6.005 s. Correspondingly, after receiving the newest configuration value, the client updates the configuration value of the configuration item 2 to the newest configuration value, and breaks the short connection.

S311: The client updates the configuration value of the configuration item 2 to the newest configuration value.

Specifically, after receiving the newest configuration value at the moment of 6.005 s, the client updates the configuration value of the configuration item 2 to the newest current configuration value of the configuration item 2 in the polling response.

Optionally, in step S308, the polling response indicating a configuration change and sent by the server to the client carries both identity information of the configuration item 2 and the newest configuration value of the configuration item 2. The newest configuration value of the configuration item 2 is dataid2% 02% group2. After receiving the polling response, the client updates the configuration value of the configuration item 2 to the newest configuration value.

Herein, it should be noted that, although the preset polling duration is 5 s, for a case in which a configuration is changed when the short connection is kept within the polling duration, it takes only approximately 1 s for the client to update the configuration value of the corresponding configuration item to the newest configuration value. To improve real-time performance of updating a configuration of a configuration item by the client, after the configuration is updated, the short connection needs to be broken immediately, so that the client sends a next polling request as soon as possible, so as to perform polling on a configuration change, thereby pushing information to the client in real time.

S312: After a preset time interval is reached, the client re-sends a polling request to the server.

After sensing that the short connection to the server is broken, the client re-sends a polling request to the server at next 1 ms, that is, a moment of 6.006 s, to performing polling on a configuration change state. The polling request includes the configuration item 1 and the configuration item 2 and respective configuration values. In this step, the configuration value of the configuration item 1 is dataid1 group1, and the configuration value of the configuration item 2 is dataid2% 2% group2.

In this example, when configuration information of a configuration item is not updated, the short connection is kept within the preset polling duration, which is equivalent to that the polling duration is extended, and a change in the configuration information of the configuration item can be sensed in time, thereby ensuring real-time performance of configuration information pushing.

### Embodiment 3

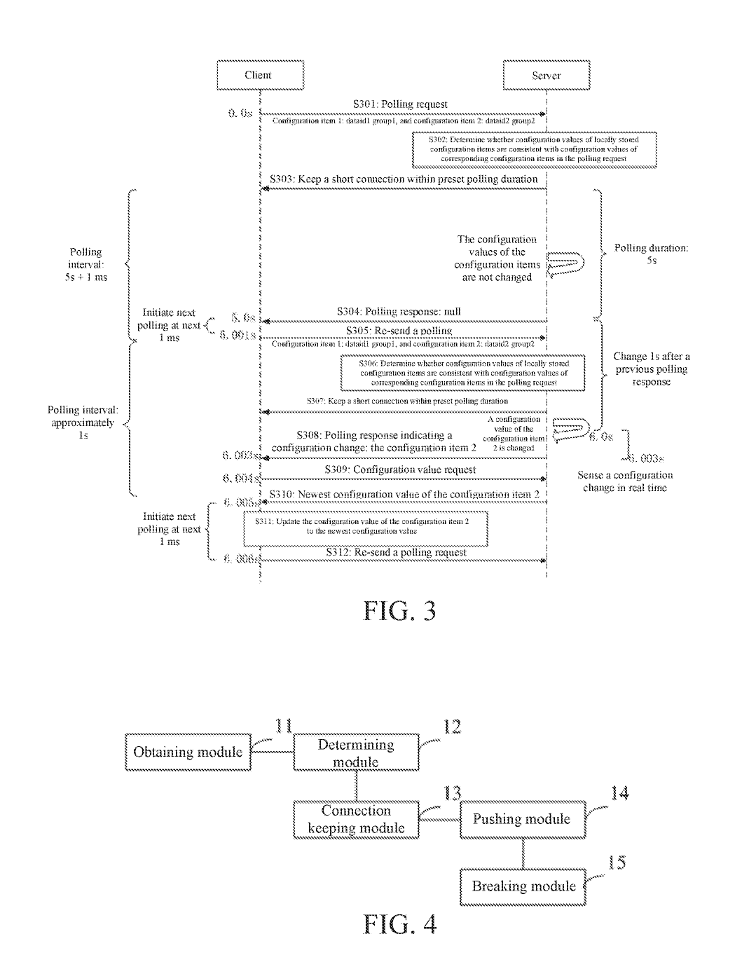

FIG. 4 is a schematic structural diagram of a configuration information push device according to Embodiment 3 of the present invention. The configuration information push device includes an obtaining module 11, a determining module 12, a connection keeping module 13, a pushing module 14, and a breaking module 15.

The obtaining module 11 is configured to obtain a polling request sent by a client, where the polling request includes configuration information of configuration items.

The determining module 12 is configured to determine whether the configuration information of the configuration items in the polling request is respectively consistent with current configuration information of corresponding local configuration items.

The connection keeping module 13 is configured to keep a short connection to the client within preset polling duration if a determining result is yes.

The pushing module 14 is configured to push, if in the duration of the short connection, current configuration information of at least one target configuration item in the local configuration items is inconsistent with configuration information of a corresponding configuration item in the polling request, the current configuration information of the target configuration item to the client, so that the client updates a configuration of a corresponding target configuration item to the current configuration information.

The breaking module 15 is configured to break the short connection to the client.

In one embodiment, the breaking module 15 is specifically configured to: push, if, in the duration of the short connection, inconsistency between current configuration information of at least one target configuration item in the local configuration items and configuration information of a corresponding configuration item in the polling request occurs the first time, the current configuration information of the target configuration item to the client, so that the client updates a configuration of the corresponding target configuration item to the current configuration information; and then break the short connection to the client.

The breaking module 15 is also configured to: when the preset polling duration is reached, break the short connection to the client.

In one embodiment, the pushing module 14 is further configured to: when the determining result of the determining module 12 is no, obtain identity information of the target configuration item from the local configuration items; and push the current configuration information of the target configuration item to the client, so that the client updates the configuration of the corresponding target configuration item to the current configuration information.

Further, the pushing module 14 is specifically configured to: send a polling response to the client, where the polling response includes the target configuration item; receive a configuration information request sent by the client; and send the current configuration information of the target configuration item to the client, so that the client updates the configuration of the target configuration item to the current configuration information.

Further, the obtaining module 11 is further configured to: after the breaking module 15 breaks the short connection to the client, after a preset time interval is reached, re-obtain a polling request sent by the client.

Further, the connection keeping module 13 is specifically configured to: when the determining result of the determining module is yes, send an asynchronous processing request to the client, so that the client keeps the short connection within the preset polling duration.

According to the configuration information push device provided in this embodiment, a polling request sent by a client is obtained; whether configuration information of configuration items in the polling request is respectively consistent with current configuration information of corresponding local configuration items is determined; if yes, a short connection to the client is kept within a preset polling duration; and if, in the duration of the short connection, current configuration information of at least one target configuration item in the local configuration items is inconsistent with configuration information of a corresponding configuration item in the polling request, the current configuration information of the target configuration item is pushed to the client, so that the client updates a configuration of the target configuration item to the current configuration information. In this embodiment, when configuration information of a configuration item is not updated, a short connection needs to be kept within preset polling duration, so that the polling duration is correspondingly extended, and a change in the configuration information of the configuration item can be sensed in time, thereby ensuring real-time performance of configuration information pushing.

### Embodiment 4

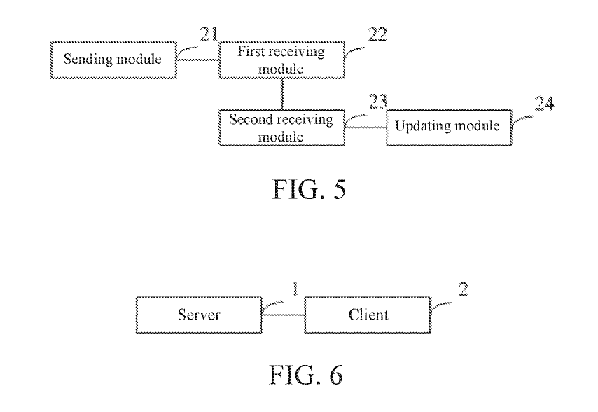

FIG. 5 is a schematic structural diagram of a configuration information updating device according to Embodiment 4 of the present invention. The configuration information push device includes a sending module 21, a first receiving module 22, a second receiving module 23, and an updating module 24.

The sending module 21 is configured to send a polling request to a server, so that the server determines whether configuration information of configuration items in the polling request is respectively consistent with current configuration information of corresponding local configuration items.

The polling request includes the configuration information of the configuration items.

The first receiving module 22 is configured to receive a connection keeping request for keeping a short connection to the server within preset polling duration that is sent by the server.

The connection keeping request is sent by the server when the server determines that the configuration information of the configuration items in the polling request is consistent with the current configuration information of the corresponding local configuration items.

The second receiving module 23 is configured to receive, from the server, a push message used to push current configuration information of a target configuration item.

The push message is sent by the server when the server determines, in the duration of the short connection, that current configuration information of at least one target configuration item is inconsistent with configuration information of a corresponding configuration item in the polling request, and the target configuration item is a configuration item in the local configuration items.

The updating module 24 is configured to update a configuration of a corresponding target configuration item at the client to the current configuration information.

Further, the sending module 21 is further configured to: before the second receiving module receives, from the server, the push message used to push the current configuration information of the target configuration item, send a configuration information request to the server, where the configuration information request is used to request the server to deliver the current configuration information of the target configuration item.

Further, the first receiving module 22 is further configured to receive an indication message for breaking the short connection that is sent by the server. The indication message is sent by the server after the preset polling duration is reached and before the server sends the push message.

Further, the sending module 21 is further configured to: after the short connection to the server is broken, re-send a polling request to the server after a preset time interval is reached. Further, the connection keeping request is an asynchronous processing request used to instruct to keep the short connection to the server within the preset polling duration.

Further, the sending module 21 is further configured to: after the updating module 24 updates the configuration of the target configuration item to the current configuration information, re-send a polling request to the server after a preset time interval is reached.

According to the configuration information push device provided in this embodiment, a polling request is sent to a server, so that the server determines whether configuration information of configuration items in the polling request is respectively consistent with current configuration information of corresponding local configuration items; if yes, a short connection to the server is kept within a preset polling duration; and if, in the duration of the short connection, current configuration information of at least one target configuration item in the local configuration items is inconsistent with configuration information of a corresponding configuration item in the polling request, a client receives a push message including the current configuration information of the target configuration item, and the client updates a configuration of the corresponding target configuration item at the client to the current configuration information. In this embodiment, when configuration information of a configuration item is not updated, a short connection needs to be kept within preset polling duration, so that the polling duration is correspondingly extended, and a change in the configuration information of the configuration item can be sensed in time, thereby ensuring real-time performance of configuration information pushing.

### Embodiment 5

FIG. 6 is a schematic structural diagram of a configuration information push system according to Embodiment 5 of the present invention. The configuration information push system includes a server 1 and a client 2. For a structure implementation and a processing process of the server 1, refer to descriptions in Embodiment 3 and FIG. 4 in this specification, and details are not described herein again. For a structure implementation and a processing process of the client 2, refer to descriptions in Embodiment 4 and FIG. 5 in this specification, and details are not described herein again.

In this embodiment, when configuration information of a configuration item is not updated, a short connection needs to be kept within preset polling duration, so that the polling duration is correspondingly extended, and a change in the configuration information of the configuration item can be sensed in time, thereby ensuring real-time performance of configuration information pushing.

Persons of ordinary skill in the art may understand that all or some of the steps of the method embodiments may be implemented by a program instructing relevant hardware. The program may be stored in a computer-readable storage medium of a computer system. When the program is executed by one or more processors of the computer system, the steps of the method embodiments are performed. The foregoing storage medium includes: any medium that can store program code, such as a ROM, a RAM, a magnetic disk, or an optical disc.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

What is claimed is:

1. An information push method, comprising:
obtaining a polling request from a client, wherein the polling request comprises configuration information of configuration items;
during a short connection to the client, monitoring current configuration information of corresponding local configuration items; and
if, current configuration information of a target configuration item in the corresponding local configuration items is inconsistent with configuration information of a corresponding configuration item in the polling request, pushing the current configuration information of the target configuration item to the client for the client to update a configuration of a corresponding target configuration item at the client to the current configuration information.

2. The method according to claim 1, before the monitoring current configuration information of corresponding local configuration items, further comprising:
determining whether the configuration information of the configuration items in the polling request is consistent with current configuration information of corresponding local configuration items; and
keeping the short connection to the client within a preset polling duration, if the configuration information of the configuration items in the polling request is consistent with current configuration information of corresponding local configuration items.

3. The method according to claim 2, before the monitoring current configuration information of corresponding local configuration items, further comprising, if the configuration information of the configuration items in the polling request is inconsistent with current configuration information of corresponding local configuration items:
sending a polling response to the client, wherein the polling response comprises identity information of the target configuration item;
receiving a configuration information request sent by the client; and
sending the current configuration information of the target configuration item to the client for the client to update the configuration of the corresponding target configuration item at the client to the current configuration information.

4. The method according to claim 2, further comprising:
breaking the short connection to the client, after pushing the current configuration information to the client.

5. The method according to claim 2, further comprising:
breaking the short connection to the client, when the preset polling duration is reached.

6. The method according to claim 5, wherein after the breaking the short connection to the client, further comprising:
after a preset time interval is reached, re-obtaining a polling request from the client.

7. The method according to claim 2, wherein the keeping the short connection to the client within a preset polling duration comprises:
sending an asynchronous processing request to the client to cause the client to keep the short connection within the preset polling duration.

8. An information updating method, comprising:
sending a polling request to a server, wherein the polling request comprises configuration information of configuration items;
receiving, from the server, a push message including current configuration information of a target configuration item, after the server determines that the current configuration information of the target configuration item in corresponding local configuration items is inconsistent with configuration information of a corresponding configuration item in the polling request; and
updating a configuration of a corresponding target configuration item at the client to the current configuration information.

9. The method according to claim 8, wherein the sending a polling request to a server comprises:
sending the polling request to the server for the server to determine whether configuration information of configuration items in the polling request is consistent with current configuration information of corresponding local configuration items at the server; and
receiving, from the server, a connection keeping request for keeping a short connection to the server within a preset polling duration, after the server determines that the configuration information of the configuration items in the polling request is consistent with the current configuration information of the corresponding local configuration items, wherein: the connection keeping request is an asynchronous processing request instructing to keep the short connection to the server within the preset polling duration.

10. The method according to claim 9, wherein before the receiving, from the server, a push message, further comprising:
sending a configuration information request to the server to request the server to deliver the current configuration information of the target configuration item.

11. The method according to claim 9, further comprising:
receiving an indication message for breaking the short connection from the server, after the preset polling duration is reached; and
after a preset time interval is reached, re-sending a polling request to the server.

12. The method according to claim 8, further comprising:
after a preset time interval, re-sending a polling request to the server.

13. A system for pushing information comprising: one or more processors and a non-transitory computer-readable storage medium storing instructions that, when executed by the processor, cause the system to perform an information pushing method, the method comprising:
obtaining a polling request from a client, wherein the polling request comprises configuration information of configuration items;
keeping a short connection to the client within a preset polling duration;
during the short connection, monitoring the current configuration information of corresponding local configuration items; and
if, current configuration information of a target configuration item in the corresponding local configuration items is inconsistent with configuration information of a corresponding configuration item in the polling request, pushing the current configuration information of the target configuration item to the client for the client to update a configuration of a corresponding target configuration item at the client to the current configuration information.

14. The system according to claim 13, wherein the method further comprises:
after pushing the current configuration information to the client, breaking the short connection.

15. The system according to claim 13, wherein before the keeping a short connection to the client within a preset polling duration, the method further comprises, if the configuration information of the configuration items in the polling request is inconsistent with current configuration information of corresponding local configuration items:
sending a polling response to the client, wherein the polling response comprises identity information on the target configuration item;
receiving a configuration information request sent by the client; and
sending the current configuration information of the target configuration item to the client for the client to update the configuration of the corresponding target configuration item at the client to the current configuration information.

16. The system according to claim 13, wherein the method further comprises:
when the preset polling duration is reached, breaking the short connection to the client.

17. The system according to claim 16, wherein after the breaking the short connection to the client, the method further comprises:
after a preset time interval is reached, re-obtaining a polling request from the client.

18. The system according to claim 14, wherein after the breaking the short connection to the client, the method further comprises:
after a preset time interval is reached, re-obtaining a polling request from the client.

19. The system according to claim 13, wherein the keeping a short connection to the client within a preset polling duration comprises:
sending an asynchronous processing request to the client to cause the client to keep the short connection within the preset polling duration.

20. The system according to claim 13, wherein the short connection is a Hypertext Transfer Protocol (HTTP) short connection.
